(19) United States
(12) Patent Application Publication
(10) Pub. No.: US 2025/0249352 A1
(43) Pub. Date: Aug. 7, 2025

(54) Providing Directional Hints to a Video Game Player

(71) Applicant: Sony Interactive Entertainment Inc., Tokyo (JP)

(72) Inventors: Jun Yen Leung, London (GB); Patrick John Connor, London (GB); Maria Chiara Monti, London (GB); Lawrence Martin Green, London (GB); Maurizio Cerrato, London (GB); Rajeev Gupta, London (GB)

(73) Assignee: Sony Interactive Entertainment Inc., Tokyo (JP)

(21) Appl. No.: 19/040,930

(22) Filed: Jan. 30, 2025

(30) Foreign Application Priority Data
Feb. 2, 2024 (GB) 2401431.8

(51) Int. Cl. A63F 13/24; A63F 13/213

(52) U.S. Cl. CPC A63F 13/24; A63F 13/213

(57) ABSTRACT

Described herein is a computer-implemented method for signalling a directional hint to a video game player of a video game system, comprising: obtaining (102), by the video game system, positional data; generating (104), based on the positional data, by a processor of the video game system, a directional hint to be signalled to the video game player; receiving (106), at a peripheral device of the video game system, the directional hint; and actuating (108) a moveable weight of the peripheral device in the direction of the directional hint, thereby biasing the weight distribution of the peripheral device in the direction of the directional hint.

### CROSS-REFERENCE TO RELATED APPLICATIONS

The present application claims priority from United Kingdom Patent Application No. 2401431.8, filed Feb. 2, 2024, the disclosure of which is hereby incorporated herein by reference.

### FIELD OF THE INVENTION

The present invention is related to providing hints to a video game player of a video game system. In particular, the present invention is related to computer-implemented methods, systems and devices for providing directional hints to a video game player of a video game system.

### BACKGROUND

The provision of directional hints is an important aspect of video gaming as such hints guide or prompt a video game player to make progress through a video game. Directional hints are usually provided to video game player visually, using arrows or other indicators on a screen, or audibly, using indicators such as audible instructions.

An issue present with these usual techniques for providing directional hints is that they can be intrusive, distracting, or non-immersive in the perception of a video game player. In modern video game systems, a video game player is often deeply immersed and engaged with the video game, so it is important to provide a directional hint to the player that is non-intrusive to improve their gameplay experience.

Furthermore, another issue present in modern video game systems is that video game players may be unaware of their immediate physical surroundings due to being immersed in the video game experience. Modern video games may require a video game player to move around in their immediate physical surroundings during gameplay. There is a risk that a video game player may accidentally collide with objects proximal to them, resulting in injury. There is therefore a need to improve the safety of video game players interacting with modern video game systems.

### SUMMARY OF INVENTION

In an aspect of the present invention there is provided a computer-implemented method for signalling a directional hint to a video game player of a video game system, comprising: obtaining, by the video game system, positional data; generating, based on the positional data, by a processor of the video game system, a directional hint to be signalled to the video game player; receiving, at a peripheral device of the video game system, the directional hint; and actuating a moveable weight of the peripheral device in the direction of the directional hint, thereby biasing the weight distribution of the peripheral device in the direction of the directional hint.

In this way, directional hints can be provided to a video game player without disrupting their experience whilst immersed in playing a video game. Directional hints can be provided to the video game player during gameplay without the need for visible or audible cues, which may be disruptive. Furthermore, directional hints can be provided to a video game player to encourage them to move away from an object in their immediate physical surroundings, thereby avoiding collision with the object and improving their safety.

Examples of such directional hints could be, for example, “move to the left”, “move forwards”, “look up”, or “look down”. In the scenario where the directional hint is “move to the left”, the weight distribution of the peripheral device is biased to the left side of the device, the left side of the device being the left side of the device from the perspective of the video game player when using the device in its intended manner. In embodiments, the peripheral device is a device that is held or worn by the video game player during gameplay that enables them to control or view aspects of a video game being run on a video game console.

In embodiments, the positional data comprises video game data. Preferably, the video game data comprises the position of a video game character in a video game environment. In this way, directional hints can be generated based on what is occurring in the video game that the video game player is playing. For example, the position of the video game character in the video game environment may be outside a door. A directional hint can therefore be generated to provide a signal to the video game player to interact with the video game system to move the video game character forwards and through the door. This can be signalled to the video game player by biasing or shifting the weight distribution of the peripheral device in a forward direction from the perspective of the video game player. The video game player can then interact with the video game system using the peripheral device to move the video game character forwards and through the door.

In various embodiments, the video game system comprises a video game console and the peripheral device. The directional hint may be generated by a processor of the video game console, which can run a video game, and this can be transmitted to the peripheral device. Alternatively, the directional hint may be generated by a processor of the peripheral device based on positional data transmitted to the device by the video game console. In further alternative embodiments, the positional data may be generated by the peripheral device and a processor of the peripheral device may generate the directional hint based on this positional data.

In various embodiments, the peripheral device is a handheld video game controller. In embodiments of the invention where the video game player is holding a handheld video game controller, the weight distribution of the controller may shift to the right side, in response to the directional hint “move to the right” or “look to the right”. This therefore indicates to the video game player that they should control the video game to move a video game character to the right or control the video game character to look to the right.

In various embodiments, the peripheral device is a virtual reality headset. In embodiments of the invention where the user is wearing a virtual reality headset, the weight distribution of the headset may shift downwards, in response to the directional hint “look down”. This will encourage the video game player to move their head to look down.

In embodiments, the positional data comprises image data captured by one or more cameras of the virtual reality headset. In this way, the processor of the virtual reality headset can generate a directional hint based on the image data captured by the one or more cameras of the headset. The image data preferably indicates the immediate physical surroundings of the wearer. The wearer is a video game player wearing the virtual reality headset. Directional hints can therefore be generated by the headset based on the physical surroundings of the wearer.

Preferably, the image data indicates the presence of an object proximal to the video game player, and the processor is configured to generate a directional hint based on the image data, the direction of the directional hint being away from the object. In this way, the headset processor can generate the directional hint to encourage the wearer to move away from the proximal object, which may be a wall of a room, for example. The safety of the wearer is therefore improved as they are less likely to accidentally stumble into, or trip over, an object during gameplay when they are immersed in the video game. For example, if an object is located to the left of the wearer, a directional hint can be generated based on the image data captured by the headset to signal to the wearer to move to the right, away from the object.

In various embodiments, the method further comprises: in response to determining that the video game player has taken an action in response to the directional hint, actuating the moveable weight of the peripheral device in a direction away from that of the directional hint, thereby biasing the weight distribution of the peripheral device to halt signalling of the directional hint to the video game player.

In various embodiments, the action comprises controlling an aspect of the video game in the direction of the directional hint. In various embodiments, the action comprises a movement of the video game player in the direction of the directional hint, away from the object proximal to the video game player.

In this way, the weight distribution of the peripheral device can be restored to a neutral, or unbiased distribution, once the player has taken an action in response to the directional hint. If the directional hint is “move to the right” the moveable weight of the peripheral device can be biased to the right side of the device from the centre. When the user has taken action to move a video game character (controlling the video game), or themselves (away from an object), to the right, the moveable weight can be biased back to the centre of the device, restoring a neutral weight distribution of the peripheral device. This halts signalling of the directional hint to the video game player.

In another aspect of the present invention there is provided a peripheral device for use with a video game system, comprising: a processor configured to receive a directional hint to be signalled to a video game player; a moveable weight; and an actuator, wherein the processor is configured to instruct the actuator to move the weight in the direction of the directional hint, thereby biasing the weight distribution of the peripheral device in the direction of the directional hint to signal the directional hint to the video game player.

In this way, directional hints can be provided to a video game player, without disrupting their immersive experience whilst playing a video game. Directional hints can be provided to the video game player during gameplay without the need for visible or audible cues, which may be disruptive. Furthermore, directional hints can be provided to a video game player to encourage them to move away from an object in their immediate physical surroundings, thereby avoiding collision with the object and improving their safety.

In the scenario where the directional hint is “move to the left”, the weight distribution of the peripheral device is biased to the left side of the device, the left side of the device being the left side of the device from the perspective of the video game player when using the device in its intended manner. In embodiments, the peripheral device is a device that is held or worn by the video game player during gameplay that enables them to control or view aspects of a video game.

Alternatively, the processor is configured to generate, based on positional data, the directional hint. In various embodiments, the processor of the peripheral device may generate the directional hint based positional data obtained by the peripheral device. A video game console of a video game system may generate the positional data, such as video game data comprising the position of a video game character in a video game environment, and transmit this to the peripheral device. The processor of the device can then generate a directional hint based on this. In alternative embodiments, the peripheral device may generate the positional data.

In various embodiments, the peripheral device comprises a passage within which the weight can move. In this way, the movable weight can move freely within the peripheral device through the passage. The passage may be a hollow tunnel or chamber within which the moveable weight can move. In various embodiments, the passage may extend from one side of the peripheral device to the other, for example from the left side to the right side. The passage may also extend from the front to the back of the peripheral device, and/or from the top to the bottom of the device.

In various embodiments, the actuator comprises a motor mechanically coupled to the weight via a coupling, the motor is configured to move the weight by actuating the coupling. In this way, the weight can be moved through the passage via operation of the motor. For example, the coupling maybe a threaded spindle and the motor may rotate the spindle, moving the weight towards or away from the motor, depending on the nature of the directional hint.

In various embodiments, the moveable weight comprises a magnet, and the actuator comprises an electromagnet configured to produce a variable magnetic field to cause the magnetic weight to move in the direction of the directional hint. In various embodiments, other means may be implemented to move the weight within the peripheral device in response to the directional hint.

In various embodiments, the peripheral device is a virtual reality headset or a handheld video game controller. In embodiments of the invention where the user is holding a handheld video game controller, the weight distribution of the controller may shift to the right side, in response to the directional hint “move to the right” or “look to the right” This therefore indicates to the video game player that they should control the video game to move a video game character to the right or control the video game character to look to the right. In embodiments of the invention where the user is wearing a virtual reality headset the weight distribution of the headset may shift downwards, in response to the directional hint “look down” or “look up”. This will encourage the video game player to move their head to look down or look up.

In embodiments of the invention where the user is wearing a virtual reality headset, the processor is configured to receive image data from one or more cameras of the virtual reality headset, the image data indicating the presence of an object proximal to a video game player, and configured to generate a directional hint based on the image data, the direction of the directional hint being away from the object.

In this way, the processor of the virtual reality headset can generate a directional hint based on the image data captured by the one or more cameras of the headset. The image data preferably indicates the immediate physical surroundings of the wearer (a video game player wearing the virtual reality headset). Directional hints can therefore be generated by the headset based on the physical surroundings of the wearer.

The headset processor can generate the directional hint to encourage the wearer of the headset to move away from the proximal object, which may be a wall of a room, for example. The safety of the wearer is therefore improved as they are less likely to accidentally stumble into, or trip over, an object during gameplay when they are immersed in the video game. For example, if an object is located to the left of the wearer, a directional hint can be generated based on the image data captured by the headset to signal to the wearer to move to the right, away from the object.

In another aspect of the present invention there is provided a video game system, comprising: a video game console; and a peripheral device described herein, wherein a processor of the video game console or the peripheral device is configured to generate, based on obtained positional data, a directional hint to be signalled to a video game player.

### BRIEF DESCRIPTION OF DRAWINGS

Aspects of the present invention will now be described, by way of example, by reference to the drawings, in which:

FIG. 1 is a flow diagram of a computer-implemented method for signalling a directional hint to a video game player of a video game system in an embodiment of the invention;

FIG. 2 is a schematic diagram of a hand-held video game controller in an embodiment of the invention;

FIG. 3 is a schematic diagram of a virtual reality headset in an embodiment of the invention;

FIG. 4 is a flow diagram of a computer-implemented method for signalling a directional hint to a video game player of a video game system in an embodiment of the invention;

and

FIG. 5 is a schematic diagram of a virtual reality headset in an embodiment of the invention.

### DETAILED DESCRIPTION

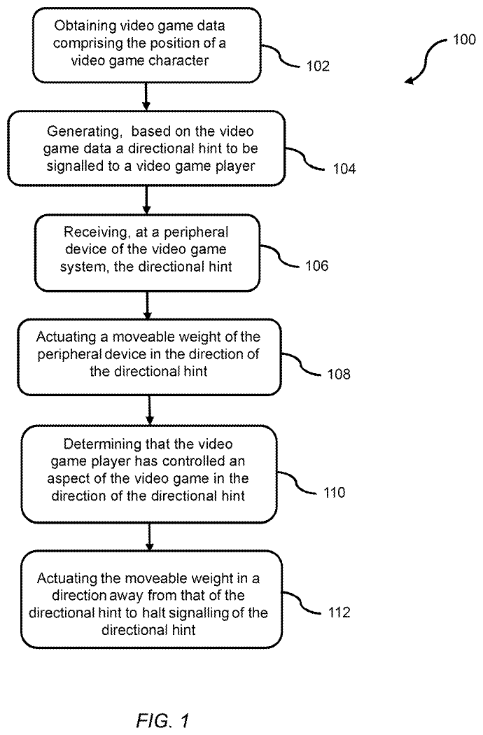

FIG. 1 is a flow diagram of a computer-implemented method 100 for signalling a directional hint to a video game player of a video game system in an embodiment of the invention. The method comprises the steps 102, 104, 106, 108, 110 and 112.

In particular, step 102 comprises obtaining, by the video game system, video game data comprising the position of a video game character in a video game environment. Step 104 comprises generating, based on the video game data, by a processor of the video game system, a directional hint to be signalled to the video game player. Step 106 comprises receiving, at a peripheral device of the video game system, the directional hint. Step 108 comprises actuating a moveable weight of the peripheral device in the direction of the directional hint, thereby biasing the weight distribution of the peripheral device in the direction of the directional hint. Step 110 comprises determining that the video game player has controlled an aspect of the video game in the direction of the directional hint in response to the directional hint and step 112 comprises actuating the moveable weight of the peripheral device in a direction away from that of the directional hint, thereby biasing the weight distribution of the peripheral device to halt signalling of the directional hint to the video game player.

At step 102, video game data comprising the position of a video game character in a video game environment is obtained by the video game system. In this embodiment, the video game system comprises a video game console and the peripheral device. The video game data is stored in a memory of the video game console and is run by a processor of the video game system. The processor of the console is therefore able to obtain data of the position of a video game character in a video game environment of the video game, based on the video game data being run. The video game data may indicate that the video game character is positioned in front of a door in the video game environment, for example.

At step 104, a directional hint to be signalled to the video game player is generated, based on the video game data, by a processor of the video game system. More specifically, the processor of the video game console generates a directional hint to be signalled to the video game player based on the position of the video game character in the video game environment. For example, in the exemplary scenario where the video game character is in front of a door in the video game environment, the processor of the video game console generates a directional hint to signal to the video game player that the character should move forwards through the door. This directional hint would comprise data indicating “move forwards”. In alternative examples, the directional hint may be “look to the left”, “move to the left”, “look to the right”, “move to the right”, “turn around” or another type of directional hint.

At step 106, the directional hint is received at a peripheral device of the video game system. The directional hint is transmitted from the processor of the video game console to the processor of the peripheral device. The console may do this via a wireless signal sent from the console to the peripheral device, or by transmitting the data via a wired connection. In this embodiment, the peripheral device may be a handheld video game controller which communicatively interacts with the video game console and controls and aspect of the video game being run. Alternatively, the peripheral device may be a virtual reality headset worn by the video game player which enables them to interact with the video game being run. In alternative embodiments, where a processor of the peripheral device generates the directional hint, the directional hint is already received at the peripheral device as it has generated the hint. In such a case the directional hint is obtained by the processor of the peripheral device.

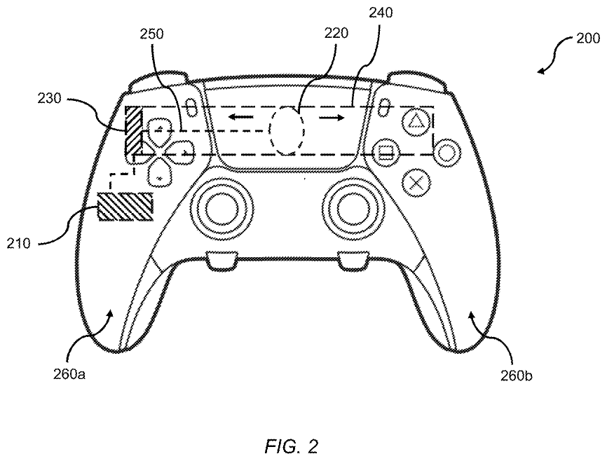

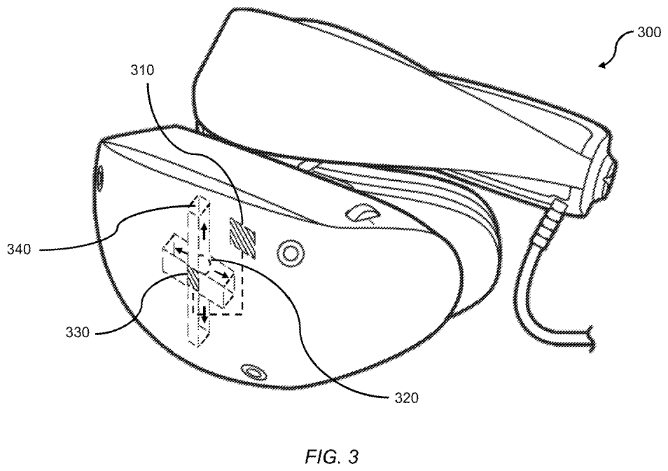

At step 108, a moveable weight of the peripheral device is actuated in the direction of the directional hint, thereby biasing the weight distribution of the peripheral device in the direction of the directional hint. In response to receiving or obtaining the directional hint, the processor of the peripheral device instructs an actuator of the device to move a movable weight of the device in the direction according to the directional hint, thereby biasing the weight distribution of the peripheral device in the direction of the hint. If the directional hint is “move forward”, for example, the actuator will bias the weight distribution of the device in a forward direction, away from the video game player. This will encourage them to operate the device (e.g. by using a button or a joystick) to control the video game in a manner that moves the video game character forwards, through a door of the video game environment, for example. Mechanisms by which the actuator may move the movable weight are described in the embodiments of the invention according FIGS. 2 and 3.

Prior to the biasing of the weight distribution of the device in the direction of the directional hint, the moveable weight may be located in a neutral position. This neutral position is that which results in an even weight distribution of the device, and as such no directional hint is signalled to the video game player. In response to a directional hint, the processor can instruct the actuator to move the weight from the neutral position to a biased position. The biased position results in an uneven weight distribution of the device, the direction of which signals the directional hint to the video game player.

At step 110, it is determined that the video game player has controlled an aspect of the video game in the direction of the directional hint in response to the directional hint. Once the video game player has operated the peripheral device and controlled the video game, it can be determined whether the video game player has controlled an aspect of the video game in the direction according to that of the directional hint. For example, the processor of the video game console may check whether the video game character of the game has been controlled to move in the direction of the directional hint.

At step 112, the moveable weight within the peripheral device is actuated in a direction away from that of the directional hint, thereby biasing the weight distribution of the peripheral device to halt signalling of the directional hint to the video game player. In response to determining that the video game player has controlled an aspect of the video game in the direction according to that of the directional hint, the actuator can move the movable weight within the device back towards the neutral position where the weight distribution of the device is balanced. For example, if a directional hint is “move forwards” and the weight of the peripheral device is biased in a forwards direction, the weight of the device can be moved backwards towards the centre of the device, thereby halting the signalling of directional hint to the video game player. In another alternative example, if a directional hint is “move to the right”, then the weight may move away from the right side, towards the left side, to the centre of the device, which is the neutral position.

FIG. 2 is a schematic diagram of a hand-held video game controller 200 in an embodiment of the invention. The video game controller 200 comprises a processor 210 and a moveable weight 220. The moveable weight 220 is operatively coupled to an actuator 230 which is configured to actuate the weight 220 in response to instructions from the processor 210. The moveable weight 220 is able to move back and forth within the controller through a passage 240. The actuator 230 is coupled to the movable weight 220 via a coupling 250 disposed within the passage. The passage 240 extends from a left side of the controller to a right side of the controller, which correspond to a left handle 260a and a right handle 160b, respectively. By moving the weight 220, the left or right handles 260a, 260b can be made heavier, thereby signalling a directional hint to the video game player holding the controller. The controller 200 may be the peripheral device of the method 100 in the embodiment of the invention according to FIG. 1.

When the processor 210 receives data from a video game console comprising a directional hint to be signalled to a video game player holding the controller 200, the processor 210 instructs the actuator 230 to move the movable weight 220 based on the directional hint received from the console. The actuator 230, in this case a motor, moves the moveable weight 220 by actuating the coupling 250, which in this case is a threaded spindle. The motor 230 rotates the coupling, thereby shortening or lengthening the length of the coupling 250 between the motor 230 and the weight 220, thereby moving the weight 220 from the left side of the passage 240 to the right side. In another embodiment there may be an alternative means implemented to move the moveable weight 220 within the controller 200 in response to receiving a directional hint.

In this embodiment, the passage 240 has a linear profile and extends from the left side of the controller 200 to the right side. In alternative embodiments, there may be a forwards and a rearwards component of the passage 240, and/or an upwards or downwards component of the passage 240. The movable weight 220 is depicted in a neutral position in the centre of the passage 240, between the left and right sides of the controller, in FIG. 2. The motor 230 is depicted as being located at the left side of the passage 240, however it may alternatively be located at the right side of the passage 240, or at another location. In this embodiment, the passage 240 is provided within the controller 200. In alternative embodiments, the movable weight 220 may be provided on a track on the exterior of the controller 200 and may move back and forwards along the track to provide the shifting of the weight distribution of the controller 200.

If the directional hint “move to the right” is received at the processor 210, the weight 220 can be moved towards the right of the controller. The video game player holding the controller 200 will then feel the right handle 260b become heavier and they will be prompted to operate the controller 200 in response to this hint. The video game player may do this by operating a button or a joystick of the controller 200, which corresponds to a movement of the video game character in the right direction.

FIG. 3 is a schematic diagram of a virtual reality headset 300 in an embodiment of the invention. The headset 300 comprises a processor 310 and a moveable weight 320. The moveable weight 320 is operatively coupled to an actuator 330 which is configured to actuate the weight 320 in response to instructions from the processor 310. The moveable weight 320 is able to move back, forth, upwards and downwards within the headset 300 through a passage 340. The passage 340 extends from a left side of the headset 300 to a right side of the headset 300, and from a top side of the headset 300 to a bottom side of the headset 300. By moving the weight 320, the left, right, top or bottom of the headset 300 can be made heavier, thereby signalling a directional hint to the video game player wearing the headset 300. The headset 300 comprises a screen (not shown), which displays a video game environment of a video game to the wearer. The headset 300 may be the peripheral device of the method 100 in the embodiment of the invention according to FIG. 1.

When the processor 310 receives data from a video game console comprising a directional hint to be signalled to a video game player wearing the headset 300, the processor 310 instructs the actuator 330 to move the movable weight 320 based on the directional hint received from the console. The actuator 330, in this case an electromagnet, moves the moveable weight 220, which is magnetic, within the passage 240 by producing a biased magnetic field to impart a force on the weight to move it in upwards direction or a downwards direction, or to the left or the right, depending on the directional hint received. In another embodiment, there may be an alternative means implemented to move the moveable weight 320 within the headset 300 in response to receiving a directional hint.

In this embodiment, the passage 340 has a cross-shaped profile and extends from the left side of the headset 300 to the right side, and from the top side of the headset 300 to the bottom side of the headset 300. In alternative embodiments, there may be a forwards and a rearwards component of the passage 340. The movable weight 320 is depicted in a neutral position in the centre of the passage 340, between the left and right sides of the headset 300, and between the top and bottom sides of the headset 300, in FIG. 3. The electromagnet 330 is depicted as being located proximal to the centre of the passage 340, however it may alternatively be located at the right side of the passage 340, or at another location. In this embodiment, the passage 340 is provided within the headset 300. In alternative embodiments, the movable weight 320 may be provided on a track on the exterior of the headset 300 and may move back and forwards along the track to provide the shifting of the weight distribution of the headset 300.

If the directional hint “look to the right” is received at the processor 310, the weight 320 can be moved towards the right of the headset 300. The video game player wearing the headset 300 will then feel the right side thereof become heavier and they will be prompted to look to the right in response to this hint. The video game player may do this by moving their head, which results in observing a different portion of the video game environment being displayed to them.

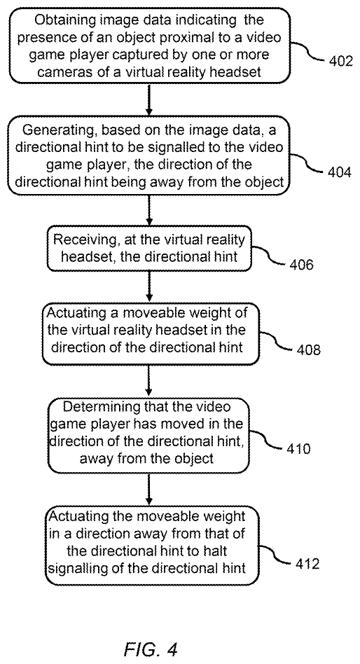

FIG. 4 is a flow diagram of a computer-implemented method 400 for signalling a directional hint to a video game player of a video game system in an embodiment of the invention. The method comprises the steps 402, 404, 406, 408, 410 and 412.

In particular, step 402 comprises obtaining, by the video game system, image data indicating the presence of an object proximal to the video game player captured by one or more cameras of a virtual reality headset. Step 404 comprises generating, based on the image data, by a processor of the video game system, a directional hint to be signalled to the video game player, the direction of the directional hint being away from the object. Step 406 comprises receiving, at the virtual reality headset, the directional hint. Step 408 comprises actuating a moveable weight of the virtual reality headset in the direction of the directional hint, thereby biasing the weight distribution of the virtual reality headset in the direction of the directional hint. Step 410 comprises determining that the video game player has moved in the direction of the directional hint, away from the object in response to the directional hint and step 412 comprises actuating the moveable weight of the virtual reality headset in a direction away from that of the directional hint, thereby biasing the weight distribution of the virtual reality headset to halt signalling of the directional hint to the video game player.

At step 402, image data indicating the presence of an object proximal to the video game player captured by one or more cameras of a virtual reality headset is obtained by the video game system. In this embodiment the video game system comprises a video game console and the virtual reality headset. Image data captured by the one or more cameras of the headset may be processed by a processor of the headset, or transmitted to the video game console for processing. Processing of the image data comprises identifying objects within the image data that could be in the immediate vicinity of the wearer of the headset.

At step 404, a directional hint to be signalled to the video game player is generated, based on the image data, by a processor of the video game system, the direction of the directional hint being away from the object. The directional hint may be generated by the processor of the headset or the console. If the image data indicates that there is an object to the left of the wearer, then a directional hint can be generated to signal to them that they should move to the right, away from the object to the left.

At step 406, the directional hint is received at the virtual reality headset. In embodiments where the headset generates the directional hint then the directional hint is implicitly received at the processor of the virtual reality headset as it has generated the hint. In embodiments where the video game console generates the directional hint, the directional hint is transmitted from the processor of the video game console to the processor of the headset. The console may do this via a wireless signal sent from the console to the headset, or by transmitting the data via a wired connection. In alternative embodiments, where the processor of the headset generates the directional hint, the directional hint is already received at the headset as it has generated the hint. In such a case the directional hint is obtained by the processor of the headset.

At step 408, a moveable weight of the virtual reality headset is actuated in the direction of the directional hint, thereby biasing the weight distribution of the virtual reality headset in the direction of the directional hint. In response to receiving or obtaining the directional hint, the processor of the headset instructs an actuator of the headset to move a movable weight of the headset in the direction according to the directional hint, thereby biasing the weight distribution of the headset in the direction of the hint. If the directional hint is “move to the right”, for example, the actuator will bias the weight distribution of the headset in the direction to the right of the wearer. This will encourage them to move to the right, away from an object to their left, for example. Mechanisms by which the actuator may move the movable weight is described in the embodiments of the invention according FIGS. 2 and 3.

Prior to the biasing of the weight distribution of the headset in the direction of the directional hint, the moveable weight may be located in a neutral position. This neutral position is that which results in an even weight distribution of the headset, and as such no directional hint is signalled to the wearer. In response to a directional hint, the processor can instruct the actuator to move the weight from the neutral position to a biased position. The biased position results in an uneven weight distribution of the headset, the direction of which signals the directional hint to the wearer.

At step 410, it is determined that the video game player has moved in the direction of the directional hint, away from the object in response to the directional hint. The virtual reality headset may comprise a gyroscope and/or accelerometer (not shown) that detects motion of the wearer of the headset to determine whether the wearer has moved in the direction of the directional hint. The processor may be operatively coupled to the gyroscope or the accelerometer in order to obtain motion data of the wearer of the headset therefrom. In alternative embodiments, the processor may obtain image data from the one or more cameras of the headset, which may indicate that the wearer of the headset has moved in the direction of the directional hint, away from the object. In further alternative embodiments, the headset may send the image or the motion data to the video game console and the video game console may process the data to determine whether or not the video game player has moved in the direction of the directional hint.

At step 412, the moveable weight of the virtual reality headset is actuated in a direction away from that of the directional hint, thereby biasing the weight distribution of the virtual reality headset to halt signalling of the directional hint to the video game player. In response to determining that the wearer has moved in the direction of the directional hint, away from the object, the actuator can move the weight within the headset back towards the neutral position where the weight distribution of the headset is balanced. For example, if a directional hint is “move to the right”, then the weight may move away from the right side, towards the left side, to the centre of the headset, which is the neutral position, thereby halting the signalling of directional hint to the wearer.

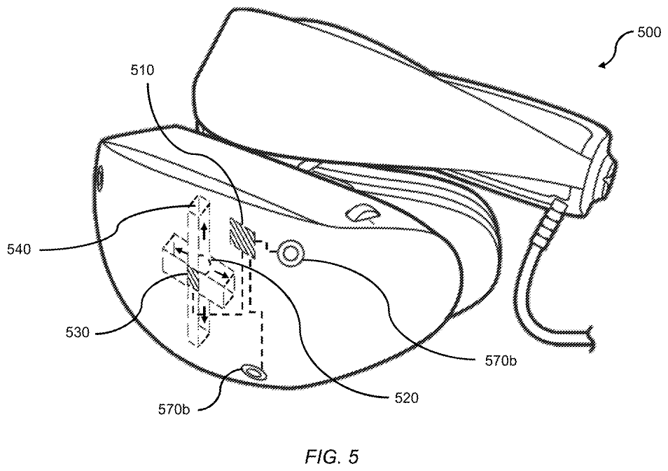

FIG. 5 is a schematic diagram of a virtual reality headset 500 in an embodiment of the invention. The headset 500 is the same as the headset 300 described in the embodiment of the invention according to FIG. 3, except in that the processor 510 of the headset 500 is additionally in communication with cameras 570a and 570b. These cameras 570a, 570b are configured to capture and feed image data to the processor 510, which can then process, or transmit the images to a video game console, to determine the position of an object proximal to the wearer of the headset 500. The headset 500 may be the headset of the method 400 in the embodiment of the invention according to FIG. 4.

1. A computer-implemented method for signalling a directional hint to a video game player of a video game system, the method comprising:
obtaining, by the video game system, positional data;
generating, based on the positional data, by a processor of the video game system, a directional hint to be signalled to the video game player;
receiving, at a peripheral device of the video game system, the directional hint; and
biasing a weight distribution of the peripheral device in the direction of the directional hint by actuating a moveable weight of the peripheral device in the direction of the directional hint.

2. The computer-implemented method according to claim 1, wherein the positional data comprises video game data.

3. The computer-implemented method according to claim 2, wherein the video game data comprises the position of a video game character in a video game environment.

4. The computer-implemented method according to claim 1, wherein the video game system comprises a video game console and the peripheral device.

5. The computer-implemented method according to claim 4, wherein peripheral device is a handheld video game controller.

6. The computer-implemented method according to claim 4, wherein the peripheral device is a virtual reality headset.

7. The computer-implemented method according to claim 6, wherein the positional data comprises image data captured by one or more cameras of the virtual reality headset.

8. The computer-implemented method according to claim 7, wherein:
the image data indicates the presence of an object proximal to the video game player; and
the processor is configured to generate the directional hint in a direction away from the object based on the image data.

9. The computer-implemented method according to claim 1, further comprising:
determining that the video game player has taken an action in response to the directional hint; and
biasing the weight distribution of the peripheral device to halt signalling of the directional hint to the video game player by actuating the moveable weight of the peripheral device in a direction away from the direction of the directional hint.

10. The computer-implemented method according to claim 9, wherein the action comprises controlling an aspect of the video game in the direction of the directional hint.

11. The computer-implemented method according to claim 9, wherein the action comprises a movement of the video game player in the direction of the directional hint and away from an object proximal to the video game player.

12. A peripheral device for use with a video game system, the peripheral device comprising:
a moveable weight and an actuator; and
a processor configured to:
receive a directional hint to be signalled to a video game player; and
bias a weight distribution of the peripheral device in the direction of the directional hint to signal the directional hint to the video game player by instructing the actuator to move the weight in the direction of the directional hint.

13. The peripheral device according to claim 12, wherein the processor is configured to generate the directional hint based on positional data.

14. The peripheral device according to claim 12, wherein the peripheral device comprises a passage within which the weight can move.

15. The peripheral device according to claim 12, wherein the actuator comprises a motor mechanically coupled to the weight via a coupling, wherein the motor is configured to move the weight by actuating the coupling.

16. The peripheral device according to claim 12, wherein:
the moveable weight comprises a magnet; and
the actuator comprises an electromagnet configured to produce a variable magnetic field to cause the weight to move in the direction of the directional hint based on the magnet.

17. The peripheral device according to claim 12, wherein the peripheral device is at least one of a virtual reality headset or a handheld video game controller.

18. The peripheral device according to claim 17, wherein the processor is configured to:
receive image data from one or more cameras of the virtual reality headset, the image data indicating the presence of an object proximal to a video game player; and
generate the directional hint in a direction away from the object based on the image data.

19. A video game system, comprising:
a video game console; and
the peripheral device of claim 12, wherein a processor of the video game console or the peripheral device is configured to generate, based on obtained positional data, the directional hint to be signalled to the video game player.
